(19) United States
(12) Patent Application Publication
(10) Pub. No.: US 2017/0336069 A1
(43) Pub. Date: Nov. 23, 2017

(54) SPIRAL FLAME TORCH APPARATUS

(71) Applicant: Armando Parra, Upland, CA (US)

(72) Inventor: Armando Parra, Upland, CA (US)

(21) Appl. No.: 15/457,918

(22) Filed: Mar. 13, 2017

Related U.S. Application Data
(60) Provisional application No. 62/306,935, filed on Mar. 11, 2016.

(51) Int. Cl. F23D 14/30; F21L 17/00; F23D 14/02; F23D 14/46

(52) U.S. Cl. CPC F23D 14/30; F23D 14/46; F21L 17/00; F23D 14/02; F23D 2900/14021

(57) ABSTRACT

An invention is provided for a spiral flame torch apparatus. The spiral flame torch apparatus generally includes a base having a bottom plate, lower stabilization plate, and an upper stabilization plate. Situated on the base is a glass halo comprised of a plurality of rounded glass sheets. The glass sheets each include vertical sides that overlap one the vertical side of another rounded glass sheet, leaving gaps between the sheets. Disposed within the glass halo is a paraffin based flame source having a large wick disposed centrally within the flame source.

### CROSS REFERENCE TO RELATED APPLICATIONS

This application claims the benefit of U.S. Provisional Patent Application having Ser. No. 62/306,935, filed on Mar. 11, 2016, by inventor Armando Parra, and entitled “Spiral Flame Torch Apparatus,” which is hereby incorporated by reference.

### BACKGROUND OF THE INVENTION

### 1. Field of the Invention

Currently, many types of torches and burners are known for mixing air and fuel to produce a flame for a variety of applications such as welding, cooking, and illumination. For some applications, such as decorative applications, a visible flame is desired independent of the heat output of the flame. Typically, decorative flame applications surround the flame with a square housing that requires structural support at the top, sides, and bottom of the torch. Such additional structural elements produce unnecessary clutter that distracts from the beauty of the fire.

### 2. Description of the Related Art

Moreover, prior art torches generally utilize an alcohol based fuel to produce the flame. Unfortunately, alcohol based fuels burn very quickly, resulting in a severely reduced burn time before the fuel needs to be replaced. For example, a prior art torches typically are only capable of burning for approximately twenty minutes before the fuel needs to be replaced. Such frequent replacement of the fuel source leads to high maintenance costs and often to reduced enjoyment of the decorative flame apparatus.

In addition, prior art torches are generally supported via a square shaped structure and therefore require additional structural support at the top of the torch apparatus. That is, prior art torches require a base as well as a structural cap at the top and often additional structure along the edges. All these additional structural articles detract from the beauty of the torch.

### SUMMARY OF THE INVENTION

The present invention addresses these needs by providing a spiral flame torch apparatus that does not require structural elements on the sides and top, and further provides a long burning flame source. As will be described in greater detail subsequently, the spiral flame torch apparatus of the embodiments of the present invention includes a base supporting a glass halo comprised of at least two sheets of rounded glass having slightly overlapping edges. Disposed within the glass halo is a paraffin based flame source. Advantageously, the spiral flame torch apparatus of the present invention provides a desirable spiraling flame that can be maintained on an incline. Moreover, the paraffin based fuel source is capable of burning for over two hours before needing replacement.

### DETAILED DESCRIPTION OF THE DRAWINGS

The invention, together with further advantages thereof, may best be understood by reference to the following description taken in conjunction with the accompanying drawings in which:

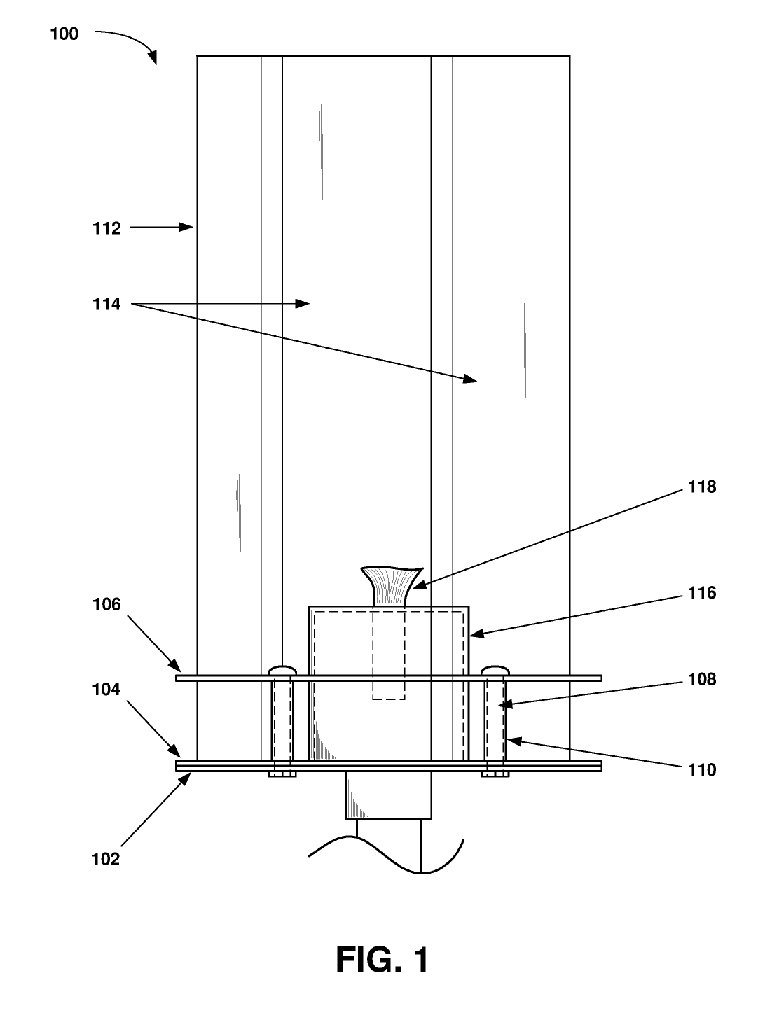

FIG. 1 is an illustration showing a side view of an exemplary spiral flame torch apparatus, in accordance with an embodiment of the present invention; and

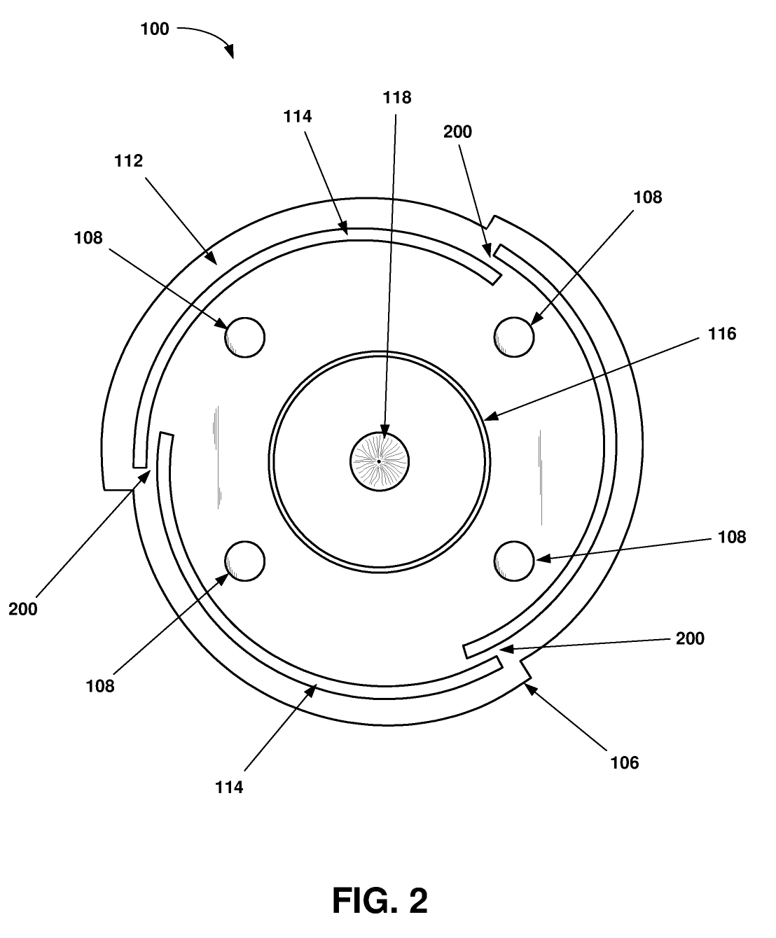

FIG. 2 is an illustration showing a top view of a spiral flame torch apparatus having a glass halo comprising three rounded glass sheets, in accordance with an embodiment of the present invention; and

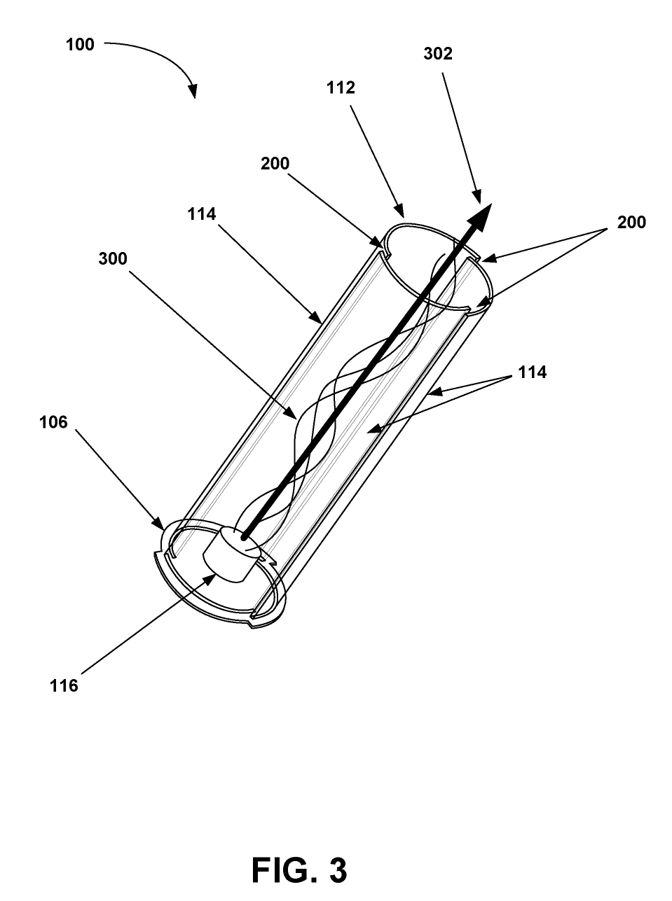

FIG. 3 shows a perspective view of a spiral flame torch apparatus, in accordance with an embodiment of the present invention.

### DETAILED DESCRIPTION OF THE INVENTION

The present invention addresses these needs by providing a spiral flame torch apparatus that does not require structural elements on the sides and top, and further provides a long burning flame source. It also provides a desirable spiraling flame that can be maintained on an incline, whereas prior art torches cannot. In general, embodiments of the present invention include a rounded cylinder shaped flame guard divided into two or more sections surrounding a paraffin based fuel source capable of burning for over two hours before needing replacement.

FIG. 1 is an illustration showing a side view of an exemplary spiral flame torch apparatus 100, in accordance with an embodiment of the present invention. The spiral flame torch apparatus 100 includes a base comprised of a bottom plate 102, a lower stabilization plate 104 disposed above the bottom plate 102, and an upper stabilization plate 106 disposed above the lower stabilization plate 104. The plates are held in place via a plurality of bolts 108. Surrounding each bolt 108 is a spacer 110, which functions to hold the upper plate 106 a predefined distance from the lower plate 104.

The spiral flame torch apparatus 100 further includes a glass halo 112. A glass halo 112 is defined as at least two rounded glass sheets 114 having two vertical sides each overlapping at least one vertical edge of another rounded glass sheet. For example, FIG. 2 is an illustration showing a top view of a spiral flame torch apparatus 100 having a glass halo 112 comprising three rounded glass sheets 114, in accordance with an embodiment of the present invention. As shown in FIG. 2, the exemplary glass halo 112 includes three rounded glass sheets 114. Each vertical side of the rounded glass sheets 114 overlaps one vertical side of another rounded glass sheet 114. In one embodiment, the rounded glass sheets 114 comprising the glass halo 112 are formed from quartz or borosilicate. The rounded glass sheets 114 can be formed by cutting a glass cylinder vertically (lengthwise) or by forming a curvature in a flat sheet of glass through a process called slumping. The rounded shape of the glass halo 112 dispenses with the need for additional structural support beyond the base described above. It should be noted that a two sided version also will stand on its own without any structural assistance. In addition, the rounded shape of the glass sheets 114 allows for minimal resistance against air flow which provides a larger, better, and faster spin for the flame inside the glass halo 112.

The gap 200 formed between the overlapping vertical sides preferably is small enough to prevent human access through the gap 200, and large enough to allow air flow through the gap 200 to the interior of the glass halo 112. As will be described subsequently, the overlapping sides of the rounded glass sheets 114 direct airflow in a particular direction that causes a unique spiraling flame effect.

Referring back to FIG. 1, the spiral flame torch apparatus 100 further includes a paraffin based flame source 116. In one embodiment, the paraffin based flame source 116 comprises a cup filled with paraffin wax. The paraffin based flame source 116 includes a large wick 118 disposed vertically within the paraffin based flame source 116 about half way deep. The large wick 118 preferably is larger than ½″ in diameter. For example, in one embodiment the large wick 118 is about ⅝″ in diameter. The paraffin based flame source 116 is disposed within the glass halo 112, generally central on the base. Both the lower plate 104 and upper plate 106 of the base include holes or gapes which allow the rounded glass sheets 114 of the glass halo 112 and the paraffin based flame source 116 to pass through and rest on the bottom plate 102 of the base.

In operation, the wick 118 of the paraffin based flame source 116 is lit and the flame source 116 is placed inside the rounded glass sheets 114 of the glass halo 112. When lit, the flame causes a pressure differential that draws in air through the gaps 200 in the glass halo 112. More specifically, the lit paraffin based flame source 116 causes the air inside the halo to rise in temperature. The sides of the glass halo 112 and the base close off most airflow except for the top and gaps 200. Hence, the hot interior air then rises and exits the interior of the glass halo 112 from the top. The exiting air causes a pressure differential or vacuum as the air is consumed by the flame. The vacuum draws in air through the gaps 200 between the overlapping rounded glass sheets 114 of the glass halo 112. As noted above, the overlapping structure of the rounded glass sheets 114 of the glass halo 112, causes the incoming air to flow in a circular motion, resulting in a unique spiraling flame effect.

Further, as the wick 118 of the paraffin based flame source 116 continues to burn, the wick 118 falls over into the fuel of the paraffin based flame source 116. As such, the fallen wick 118 creates a larger surface area for the burn. That is, the fallen wick 118 causes a more linear vacuum versus horizontal (three-dimensional) vacuum. The result is a more enhanced and unique spiral flame effect. Moreover, the paraffin of the paraffin based flame source 116 allows the flame to burn for two or more hours, resulting in a very long lived flame effect before needing to change the flame fuel source.

FIG. 3 shows a perspective view of a spiral flame torch apparatus 100, in accordance with an embodiment of the present invention. As shown in FIG. 3, the flame torch apparatus 100 can be set at an incline and maintain a spinning flame effect 300 about an axis 302 that is parallel to the glass sheets 114 of the glass halo 112 a perpendicular to the upper stabilization plate 106 of the base. As noted above, the glass halo 112 includes three rounded glass sheets 114. Each vertical side of the rounded glass sheets 114 overlaps one vertical side of another rounded glass sheet 114. The gap 200 formed between the overlapping vertical sides is designed to not to disrupt the flow of air and yet maintain a certain amount for the spin effect on the flame 300 to remain effectual along the desired axis 302.

The pressure force created by the constant balanced flow of outside air being vacuumed into the chamber through the gaps 200 between the sheets of glass 114 of the glass halo 112 causes a whirlwind effect, a vortex, inside interior of the glass halo 112, as noted above. The position of the sheets of glass sheets 114 in relationship to each other in terms of circular continuous overlap and interior gapping 200 at the overlaps dictates how much air is allowed to flow into the interior of the glass halo 112. The amount of pressure created inside of the interior of the glass halo 112 and amount of air flow required is dictated by the type and amount of energy originating inside the interior of the glass halo 112. Energy such as fire requires a greater amount of air flow therefore creating a higher pressure vacuum where the heat from the fire escapes through the opening at the top of the glass halo 112. As a result, the glass halo 112 can be tilted at an angle and in even warped to a certain extent while keeping the centerline pressure inside the chamber intact and allowing the high pressure escape route of the energy inside the chamber such as fire to follow this route to the end of the glass halo 112. For clarification, the energy originating inside the chamber can be such things as fire, smoke, and vapor.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the above described invention.

What is claimed is:

1. A spiral flame torch apparatus, comprising:
a base;
a glass halo disposed on the base; and
a paraffin based flame source situated on the base and within the glass halo.
